(19) United States
(12) Patent Application Publication
(10) Pub. No.: US 2025/0175071 A1
(43) Pub. Date: May 29, 2025

(54) FIELD CONFIGURABLE ARRAY OF POWER PROCESSING BLOCKS

(71) Applicant: Nextracker LLC, Fremont, CA (US)

(72) Inventors: Alexander W. Au, Oakland, CA (US); Jason Sean Henry, Palo Alto, CA (US); Niloofar Torabi, Redwood City, CA (US); Micah Erickson, Fremont, CA (US)

(21) Appl. No.: 18/962,627

(22) Filed: Nov. 27, 2024

Related U.S. Application Data
(60) Provisional application No. 63/603,107, filed on Nov. 27, 2023.
(60) Provisional application No. 63/676,667, filed on Jul. 29, 2024.

(51) Int. Cl. H02M 1/00; H02J 3/38; H02M 3/158; H02M 7/5395

(52) U.S. Cl. CPC H02M 1/0067; H02M 3/158; H02M 7/5395; H02J 3/38; H02J 2300/26

(57) ABSTRACT

A field configurable array of power processing blocks can include a plurality of power processing blocks configured to operate as DC/DC converters and/or DC/AC inverters. The field configurable array of power processing blocks can further include a controller configured to adjust the number of DC/DC converters and/or DC/AC converters. The controller can reconfigure the power processing blocks operating as a DC/DC converter such that the power processing blocks operate as a DC/AC converter and vice versa. In some embodiments, the controller of the field configurable array is configured to adjust connections between PV arrays, energy storage, and the grid to ensure maximum efficiency.

### RELATED APPLICATIONS

The present application claims the benefit of, and priority to, U.S. Provisional Patent Application Ser. No. 63/603,107, filed on Nov. 27, 2023, and to U.S. Provisional Patent Application Ser. No. 63/676,667, filed on Jul. 29, 2023, the entire contents of which are hereby incorporated by reference in their entirety.

### TECHNICAL FIELD

This disclosure generally relates to electrical power converters and inverters.

### BACKGROUND

Integrating multiple renewable energy sources together, such as different arrays of photovoltaic (PV)/solar panels, and further integrating energy storage devices, such as batteries, can be complex. Current solutions often involve using separate power converters, such as DC/DC power converters, and inverters for each energy source and/or for each energy storage device. Further, if more renewable energy capacity and/or energy storage is added after a system has already been built, additional power converters and inverters are needed to interconnect the existing renewable energy sources and energy storage devices with the new renewable energy sources and energy storage devices.

### SUMMARY

In general, this disclosure describes a field configurable array of power processing blocks. In particular, embodiments disclosed herein enable multiple renewable energy sources and/or energy storage devices to be connected to each other/one another and to an electrical grid more easily by combining electrical power converters (e.g., DC/DC converters) and inverters (e.g., DC/AC inverters) into one or more power processing blocks. In addition, embodiments disclosed herein enable additional renewable energy sources and/or additional energy storage devices to be connected to existing systems by making the power processing block configurable.

In an example, a configurable power block system comprises a first series of power processing blocks configured to convert between a first DC voltage and a second DC voltage; a second series of power processing blocks configured to convert power between one of the first DC voltage or the second DC voltage and an AC voltage; a first electrical input/output connection connectable to a first electrical supply/load; a second electrical input/output connection connectable to a second electrical supply/load; and a controller in communication with the first series of power processing blocks and the second series of power processing blocks. The controller can be configured to: determine a number of power processing blocks of the first series of power processing blocks required to process power between the first electrical input/output connection and the second electrical input/output connection; and determine a number of power processing blocks of the second series of power processing blocks required to process power between the first electrical input/output connection and the second electrical input/output connection. The controller can be further configured to make a series of electrical connections to convert power between the first DC voltage at the first electrical input/output connection and the AC voltage at the second electrical input/output connection with the series of electrical connections comprising: electrically connecting the required number of power processing blocks of the first series of power processing blocks into a first group of power processing blocks; electrically connecting the required number of power processing blocks of the second series of power processing blocks into a second group of power processing blocks; electrically connecting the first electrical input/output connection with the first group of power processing blocks; electrically connecting the second electrical input/output connection with the second group of power processing blocks; and electrically connecting the first group of power processing blocks with the second group of power processing blocks.

In another example, a method of configuring a configurable power block system comprises: determining a number of first power processing blocks required to process power between a first electrical input/output connection and a second electrical input/output connection, the first power processing blocks configured to convert power between a first DC voltage and a second DC voltage; determining a number of second power processing blocks required to process power between the first electrical input/output connection and the second electrical input/output connection, the second power processing blocks configured to convert power between the second DC voltage and an AC voltage; and making a series of electrical connections to convert power between the first DC voltage at the first electrical input/output connection and the AC voltage at the second electrical input/output connection. The series of electrical connections can comprise: electrically connecting the required number of the first power processing blocks into a first group of power processing blocks; electrically connecting the required number of the second power processing blocks into a second group of power processing blocks; electrically connecting the first electrical input/output connection with the first group of power processing blocks; electrically connecting the second electrical input/output connection with the second group of power processing blocks; and electrically connecting the first group of power processing blocks with the second group of power processing blocks.

The example method can further comprise: determining a number of the first power processing blocks required to process power between a third electrical input/output connection and the second electrical input/output connection; determining a number of the second power processing blocks required to process power between the third electrical input/output connection and the second electrical input/output connection; and making a second series of electrical connections to convert power between the first DC voltage at the first electrical input/output connection and the AC voltage at the second electrical input/output connection, the series of electrical connections comprising: electrically connecting the required number of the first power processing blocks into a third group of power processing blocks; electrically connecting the required number of the second power processing blocks into a fourth group of power processing blocks; electrically connecting the third electrical input/output connection with the third group of power processing blocks; electrically connecting the second electrical input/output connection with the fourth group of power processing blocks; and electrically connecting the third group of power processing blocks with the fourth group of power processing blocks.

In some examples, the third group of power processing blocks includes one or more power processing blocks of the first group of power processing blocks. In some examples, the fourth group of power processing blocks includes one or more power processing blocks of the second group of power processing blocks.

In yet another example, a configurable power block system comprises: a first series of power processing blocks configured to convert between a first DC voltage and a second DC voltage; a second series of power processing blocks configured to convert power between one of the second DC voltage and an AC voltage; a first electrical input/output connection connectable to a first electrical supply/load; a second electrical input/output connection connectable to a second electrical supply/load; and a plurality of switches. The plurality of switches can be configurable to: electrically connect one or more of the first series of power processing blocks with another one or more of the first series of power processing blocks to form a first group of power processing blocks configured to convert between the first DC voltage and the second DC voltage; electrically connect one or more of the second series of power processing blocks with another one or more of the second series of power processing blocks to form a second group of power processing blocks configured to convert between the second DC voltage and the AC voltage; electrically connect the first group of power processing blocks with the first electrical supply/load; and electrically connect the second group of power processing blocks with the second electrical supply/load.

In the example, the first electrical supply/load can comprise a photovoltaic (PV) array, and the second electrical supply/load can comprise an electrical grid.

Further, in the example, the plurality of switches can be further configurable to: electrically connect one or more of the first series of power processing blocks with another one or more of the first series of power processing blocks to form a third group of power processing blocks configured to convert between the first DC voltage and the second DC voltage; electrically connect one or more of the second series of power processing blocks with another one or more of the second series of power processing blocks to form a fourth group of power processing blocks configured to convert between the second DC voltage and the AC voltage; electrically connect the third group of power processing blocks with a third electrical input/output connection; and electrically connect the fourth group of power processing blocks with the second electrical input/output connection.

Additionally, in the example, the third electrical input/output connection can be connectable to a third supply/load that comprises energy storage, and the second electrical supply/load can comprise an electrical grid.

In another example, a processing block for converting power between a first voltage and a second voltage comprises a plurality of sub-processing blocks, each of the plurality of sub-processing blocks configured to convert power between a first voltage and a second voltage; a plurality of inductors, each of the plurality of inductors coupled to a corresponding sub-processing block of the plurality of sub-processing blocks; a plurality of bi-directional ports couplable with one or more of the plurality of sub-processing blocks; and a control board in communication with each of the plurality of sub-processing blocks. The control board can be configured to: control switching of each of the plurality of sub-processing blocks for the plurality of sub-processing blocks to convert power between the first voltage and the second voltage; and connect one or more of the bi-directional ports with one or more of the plurality of sub-processing blocks depending on the first voltage and the second voltage.

In the example, the first voltage can comprise a first DC voltage and the second voltage can comprise one of a second DC voltage or an AC voltage.

The details of one or more examples are set forth in the accompanying drawings and the description below. Other features, objects, and advantages will be apparent from the description and drawings, and from the enumerated embodiments.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a schematic view of an example system including a field configurable array of power processing blocks according to an aspect of the present disclosure.

FIG. 2 is a schematic view of an example system including a field configurable array of power processing blocks in an alternate configuration according to an aspect of the present disclosure.

FIG. 3A is a schematic view of an example system including a field configurable array of power processing blocks in a first configuration according to an aspect of the present disclosure.

FIG. 3B is a schematic view of the example system including the field configurable array of power processing blocks of FIG. 3A in a second configuration according to an aspect of the present disclosure.

FIG. 3C is a schematic view of the example system including the field configurable array of power processing blocks of FIG. 3A in a third configuration according to an aspect of the present disclosure.

FIG. 4 is a schematic view of an example system including a field configurable array of power processing blocks in a fourth configuration according to an aspect of the present disclosure.

FIG. 5 is a schematic view of an example power processing block in a DC/AC configuration according to an aspect of the present disclosure.

FIG. 6 is a schematic view of an example power processing block in a DC/DC configuration according to an aspect of the present disclosure.

FIG. 7A is a schematic view of an example sub-processing block according to an aspect of the present disclosure.

FIG. 7B is a schematic view of an alternate example sub-processing block according to an aspect of the present disclosure.

FIG. 8 is a flow diagram of an example method of configuring a field configurable array of power processing blocks according to an aspect of the disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

In this disclosure, DC/DC converters generally refer to electronics that can convert a first DC voltage to a second DC voltage. Similarly, DC/AC inverters (also referred to as DC/AC converters) generally refer to electronics that can convert a DC voltage to an AC voltage.

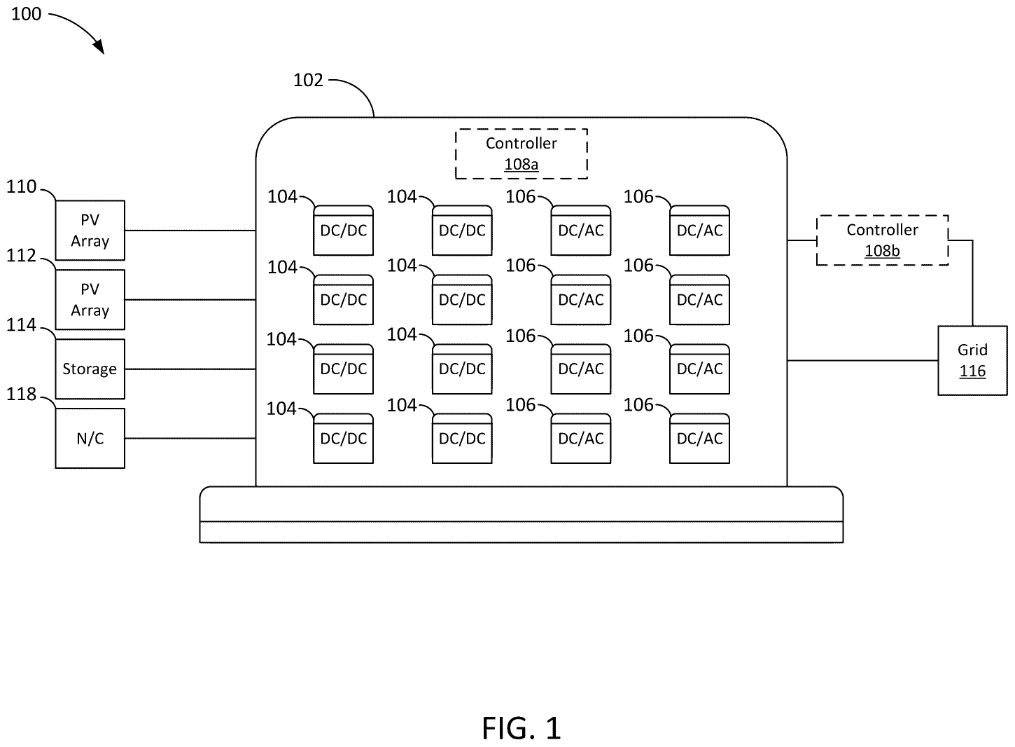

FIG. 1 is a schematic view of an example system 100 including a field configurable array of power processing blocks 102 according to an aspect of the present disclosure. The field configurable array of power processing blocks 102, also referred to herein as field configurable array 102, comprises the power processing blocks 104, 106 which are in either a DC/DC configuration (e.g., 104) or in an DC/AC configuration (e.g., 106). The DC/DC power processing blocks 104 can convert a DC voltage to a higher or lower DC voltage. In some embodiments, the DC/DC power processing blocks 104 also performs optimization, such as maximum power point tracking (MPPT), on the input. Each of the DC/DC power processing blocks 104 can be rated to operate at a maximum power level, for example, 250 kVA. In comparison, the DC/AC power processing blocks 106 can convert a DC voltage input to an AC voltage output. In some embodiments, though, the DC/AC power processing blocks 106 can convert an AC voltage input to a DC voltage output. Each of the DC/AC power processing blocks 106 can be rated to operate at a maximum power level, for example, 250 kVA.

As is further detailed elsewhere herein, the field configurable array 102 can comprise any number of DC/DC power processing blocks 104 and any number of DC/AC power processing blocks 106. In the embodiment of FIG. 1, though, an equal number of DC/DC power processing blocks 104 and DC/AC power processing blocks 106 are included in the field configurable array 102.

The field configurable array 102 can also include various internal connections. For instance, the field configurable array 102 can include connections between different DC/DC power processing blocks 104, between different DC/AC power processing blocks 106, and connections between DC/DC power processing blocks 104 and DC/AC power processing blocks 106. Connections between the internal components can be configured such that any power processing block 104, 106 can be connected to any number of other power processing blocks. For example, one or more DC/DC power processing blocks 104 can be connected to one or more DC/AC power processing blocks. In some examples, an internal controller 108a is used to configure any internal/external connections of the field configurable array 102 while in some examples, an external controller 108b is used to configure any internal/external connections of the field configurable array. In some embodiments, both an internal controller 108a and an external controller 108b are used to configure internal/external connections of the field configurable array 102.

The field configurable array 102, is connected to various inputs and outputs. In the embodiment of FIG. 1, the field configurable array 102 is connected to a first PV array 110, a second PV array 112, energy storage 114, and the grid 116. The field configurable array 102 also includes an input which is not connected 118. The inputs and the outputs to the field configurable array 102 can be connected to various power processing blocks 104, 106. For example, the first PV array 110 can be connected to one or more DC/DC power processing blocks 104, while the grid 116 can be connected to one or more DC/AC power processing blocks 106. In some examples, inputs are connected to the DC/DC power processing blocks 104 and outputs are connected to the DC/AC power processing blocks 106. In some such examples, the inputs to the field configurable array 102 may only operate using DC voltage while an output of the field configurable array 102 (e.g., the grid 116) may only operate using AC voltage. Internal connections between the DC/DC power processing blocks 104 and the DC/AC power processing blocks 106 can connect an input, such as the first PV array 110, with an output, such as the grid 116. Accordingly, any power generated by the first PV array 110 can be output to the grid 116 through the field configurable array 102.

In some embodiments, inputs are connected to DC/AC power processing blocks 106 while outputs are connected to DC/DC power processing blocks 104. For example, the grid 116 can act as an input to the field configurable array 102 to charge the energy storage 114, which accordingly acts as an output. In some examples, the grid 116 and the energy storage 114 both act as an input and an output to the field configurable array 102. The energy storage 114 can be charged by the grid 116 (e.g., at a first time) and the energy storage 114 can discharge to the grid 116 (e.g., at a second time). Generally, an input is defined as inputting electrical energy into the field configurable array 102 while an output is defined as receiving electrical energy from the field configurable array 102. However, as one having ordinary skill in the art will appreciate, what constitutes an input vs. an output can change and this disclosure does not limit a connection to only be an input or an output.

The connections between the various inputs and outputs of the field configurable array 102 can be considered external connections. For instance, the connection between the first PV array 110 and the field configurable array 102 can be an external connection as the first PV array 110 is external to the field configurable array 102. The external connections can be configurable. For example, the first PV array 110 can be configured to disconnect and/or connect to the non-connected input 118. In another example, the grid 116 can be configured to disconnect from one or more DC/AC power processing blocks 106 and connect to one or more alternate DC/AC power processing blocks. An internal controller 108a and/or an external controller 108b can be used to configure external connections of the field configurable array 102.

In some embodiments, the field configurable array 102 includes, or is connected to, three buses/rails for connections to/from the field configurable array 102. For example, a first bus can be a DC bus, a second bus can be a different DC bus, and a third bus can be an AC bus. The first DC bus can be a common bus for connections within the field configurable array 102. For example, both the output sides of the DC/DC power processing blocks 104 and the input sides of the DC/AC power processing blocks 106 can be connected to the first DC bus. The second DC bus can be a common bus for the inputs, or outputs in the case of energy storage 114, to the field configurable array 102. For example, the PV arrays and energy storage can output DC power to the second DC bus, which is then used as an input to the DC/DC power processing blocks 104 of the field configurable array 102. The third, AC bus can similarly be a common bus for the output(s), or input(s) if energy storage 114 is being used, from the field configurable array 102. For example, the outputs of the DC/AC power processing blocks 106 can be connected to the AC bus which is connected to the grid 116.

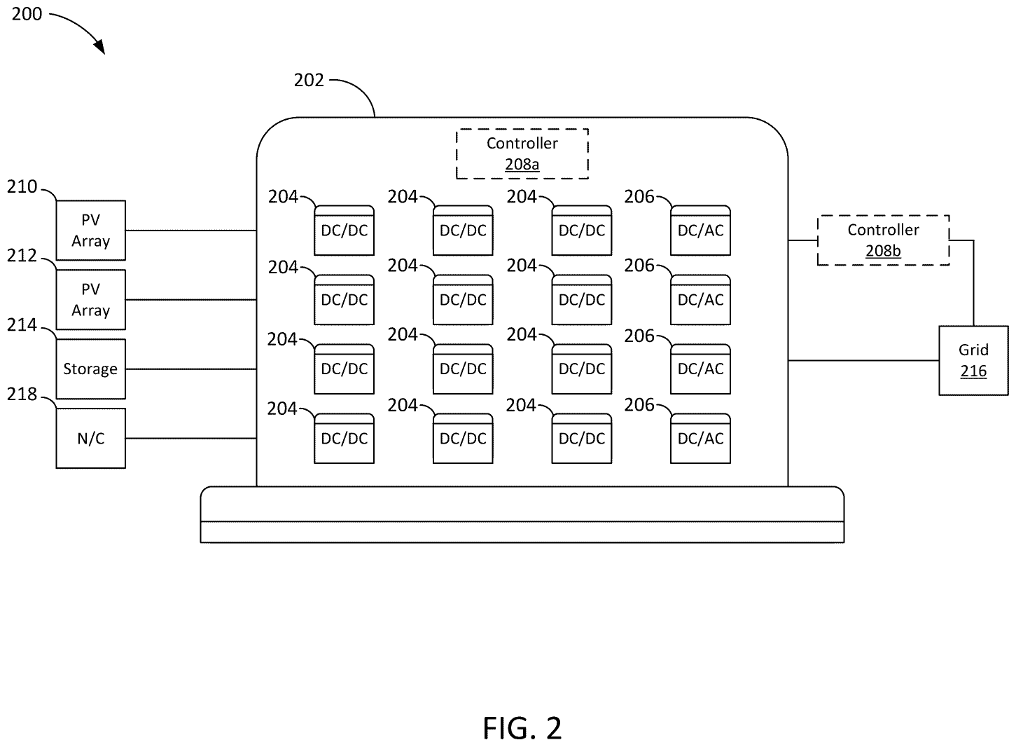

FIG. 2 is a schematic view of an example system 200 including a field configurable array of power processing blocks 202 in an alternate configuration according to an aspect of the present disclosure. In comparison to the example system 100 of FIG. 1, the field configurable array 202 includes a different number of DC/DC power processing blocks 204 and DC/AC power processing blocks 206. While the example field configurable array 102 of FIG. 1 has an equal number (e.g., eight) of DC/DC power processing blocks 104 and DC/AC power processing blocks 106, the field configurable array 202 of FIG. 2 has more DC/DC power processing blocks 204 (e.g., twelve) than DC/AC power processing blocks 204 (e.g., four). In some embodiments, the decreased number of DC/AC power processing blocks 206 relative to DC/DC power processing blocks 204 is because the DC/AC power processing blocks 206 operate at a greater maximum power level than the DC/DC power processing blocks 204.

In some embodiments, the decreased number of DC/AC power processing blocks 206 relative to DC/DC power processing blocks 204 is due to different requirements for the inputs/outputs to/from the field configurable array 202. For example, the field configurable array 202 may include energy storage 214 which is configured to charge when the first PV array 210 and the second PV array 212 are producing power discharge when the first PV array 210 and the second PV array 212 are not producing power. In such an example, the energy storage 214 may need to be connected to DC/DC power processing blocks when the PV arrays 210, 212 are producing power (e.g., to store the electrical power), but the energy storage 214 only uses DC/AC power processing blocks 206 when discharging to the grid 216. Accordingly, the DC/AC power processing blocks 206 can be used to discharge power to the grid 216 from the PV arrays 210, 212 when they are producing power, and can be used to discharge power to the grid from the energy storage 214 when the PV arrays 210, 212 are not producing power. Thus, because the DC/AC power processing blocks 206 are not being used by both the PV arrays 210, 212 and the energy storage 214 at the same time, fewer DC/AC power processing blocks 206 may be required relative to DC/DC power processing blocks 204.

A DC/DC power processing block 204 can be configured to become a DC/AC power processing block 206. Similarly, a DC/AC power processing block 206 can be configured to become a DC/DC power processing block 204. In some embodiments, the number of DC/DC power processing blocks 204 and/or the number of DC/AC power processing blocks 206 can be adjusted by a controller (e.g., 208a, 208b). For example, the internal controller 210a can increase the number of DC/AC power processing blocks 206 by converting one or more DC/DC power processing blocks 204 into one or more DC/AC power processing blocks 206. Alternatively, the internal controller 210a can increase the number of DC/DC power processing blocks 204 by converting one or more DC/AC power processing blocks 206 into one or more DC/DC power processing blocks 204. In some embodiments, the controller can receive information from connected inputs (e.g., PV arrays 210, 212, energy storage 214) and outputs (e.g., grid 216) and use the information to change a ratio of DC/DC power processing blocks 204 to DC/AC power processing blocks 206. The information can comprise real-time measurements such as power generated by a PV array, a capacity of energy storage, an amount of charge of energy storage, operational health of various systems (e.g., failure of a PV array, energy storage, DC/DC, and/or DC/AC power converters), any faults in sub-systems (e.g., connections between components) among other factors that are contemplated.

In some embodiments, the controller (e.g., 208a, 208b) includes a wired and/or wireless connection such that a remote user can configure the controller and/or instruct the controller to perform one or more actions. For example, a remote user can instruct the controller to change one or more DC/DC power converters to one or more DC/AC power converter. In another example, a remote user can instruct the controller to change inputs and/or outputs to the field configurable array, such as changing a non-connection 218 to a PV array. Additionally or alternatively, the controller can perform such functions automatically, if it is configured in a dynamic operation mode. The controller can comprise one or more processors in communication with computer readable memory storing instructions that, when executed by the one or more processors, cause the controller to perform the functions described elsewhere herein.

In some examples, it can be advantageous to decrease the number of DC/DC power processing blocks 204 relative to the number of DC/AC power processing blocks 206. For example, the number of DC/DC power processing blocks 204 and DC/AC power processing blocks 206 can initially be set such that the field configurable array 202 can operate at a maximum power input from PV arrays and/or energy storage. However, PV arrays and/or energy storage devices do not always operate at maximum power output to the field configurable array 202. By reducing the number of DC/DC power processing blocks being used, each DC/DC power processing block can operate closer to its rated maximum power, which coincides with an increase in conversion efficiency. In some examples, to achieve such an increase in efficiency, a controller (e.g., internal controller 208a) can change which inputs to the field configurable array are connected to each DC/DC processing block. For example, the internal controller 208a can disconnect a first PV array from a first DC/DC power processing block and connect the first PV array to a second power processing block that is also connected to a second PV array. In such an example, the second DC/DC power processing block can operate closer to its maximum rated power level, increasing efficiency, while the first DC/DC power processing block can be disconnected and/or reconfigured to become a DC/AC power converter.

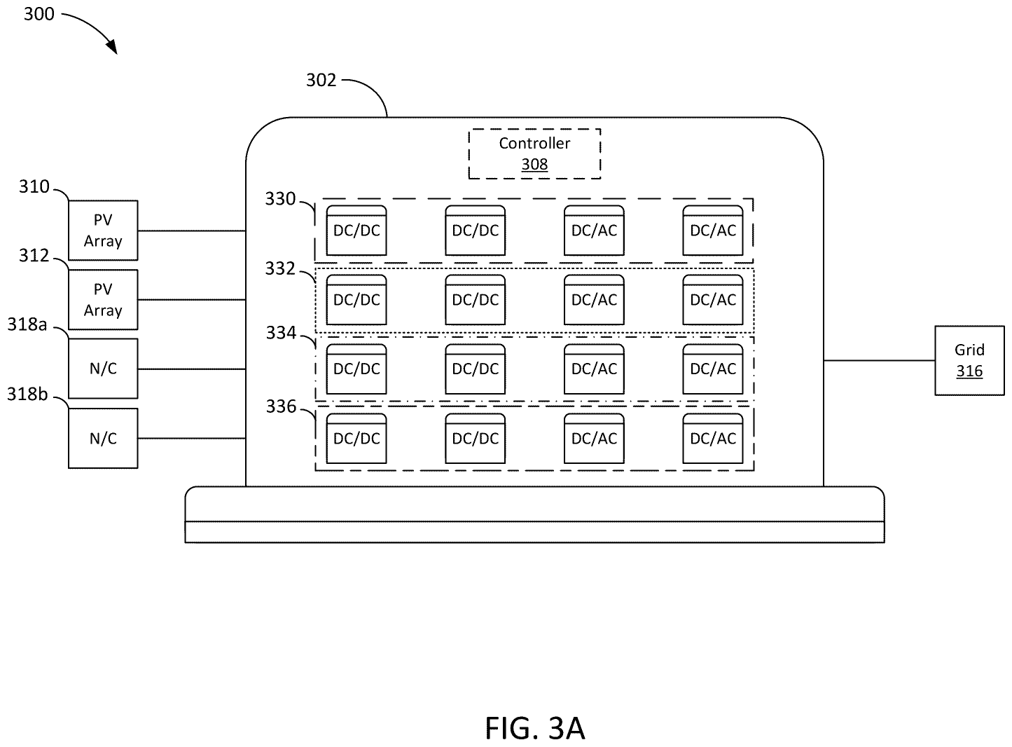

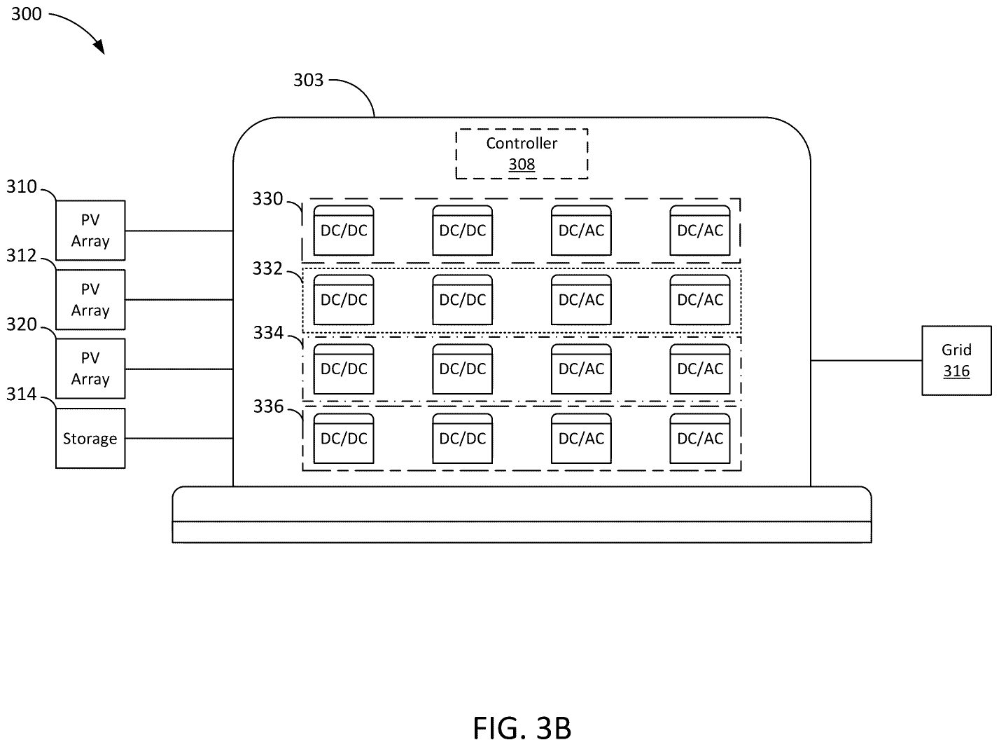

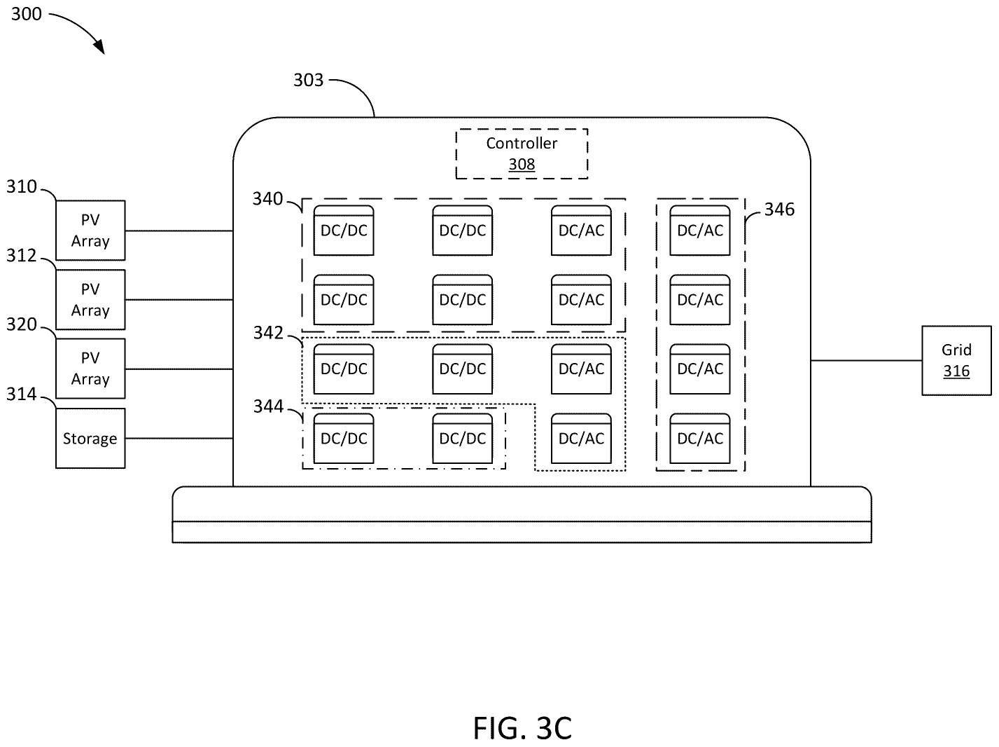

FIG. 3A is a schematic view of an example system 300 including a field configurable array of power processing blocks 302 in a first configuration according to an aspect of the present disclosure. In the first configuration, a first PV array 310 is connected to a first group 330 of power processing blocks and a second PV array 312 is connected to a second group 332 of power processing blocks. Additionally, the first configuration includes a first non-connection 318a and second non-connection 318b. The non-connections 318a, 318b can each represent a connection point that is not currently connected, but to which a future connection or connections could be made. In the embodiment of FIG. 3A, the first non-connection 318a is connected to a third group 334 of power processing blocks while the second non-connection 318b is connected to a fourth group 336 of power processing blocks. The third and fourth group 334, 336 of power processing blocks can be pre-configured, as in the embodiment of FIG. 3A, to simplify new connections to the field configurable array 302. Additionally or alternatively, in some embodiments, the third and fourth group 334, 336 of power processing block can be configured in real time to accommodate changes in connected PV arrays and/or energy storage. For example, a power processing block or blocks in the first and/or second groups 330, 332 of power processing blocks may fail. In such a case, a processing block or blocks from the third and/or fourth groups 334, 336 can be used to replace the functionality of the inoperable power processing block(s). In some examples, if one type of power processing block fails (e.g., DC/AC power processing block) and no replacements of that type are available, a controller (e.g., 308) can configure the other type of power processing block (e.g., DC/DC power processing block) into a replacement. The controller can perform this function dynamically which can increase a fault tolerance of the field configurable array 302 and reduce downtime.

In some embodiments, the groups 330, 332, 334, 336 of power processing blocks can be independently connected to the grid 316. Alternatively, in some embodiments, one or more of the groups 330, 332, 334, 336 of power processing blocks are coupled together, such as to a common AC bus, before connecting to the grid 316.

FIG. 3B is a schematic view of the example system 300 including the field configurable array of power processing blocks 302 of FIG. 3A in a second configuration according to an aspect of the present disclosure. In the second configuration, a third PV array 320 is connected to the third group 334 of power processing blocks in replacement of the first non-connection 318a. Additionally, an energy storage 314 is connected to the fourth group 336 of power processing blocks in replacement of the second non-connection 318b. The second configuration thus differs from the first configuration in that additional PV capacity and energy storage is added. By including additional DC/DC and DC/AC power processing blocks, and enabling them, the field configurable array 302 can be configured to accept additional inputs/outputs. The ability to accept additional inputs/outputs increases the adaptability and scalability of the field configurable array 302 and the corresponding power plant (e.g., PV arrays).

To ensure that the additional inputs/outputs work properly, the controller 308 can configure the third group 334 of power processing blocks to operate in the same manner as the first and second groups 330, 332 of power processing blocks. Further, the controller 308 can configure the fourth group 336 of power processing blocks to operate such that power can flow both into and out of the energy storage 314. For example, the controller 308 can selectively enable connections between the groups of power processing blocks to enable power to be directed from the PV arrays 310, 312, 320 to the energy storage 314. Further, the controller 308 can selectively disable connections between the groups of power processing blocks and enable a connection between the fourth group 336 of power processing blocks and the grid 316 to enable power to be directed from/to the energy storage 314 to/from the grid 316.

FIG. 3C is a schematic view of the example system including the field configurable array of power processing blocks of FIG. 3A in a third configuration according to an aspect of the present disclosure. In the third configuration, the same inputs/outputs of the second configuration are used. For example, the first PV array 310, the second PV array 312, and the third PV array 320 are used as inputs while the energy storage 314 and the grid 316 are used as inputs/outputs (e.g., to charge/discharge the energy storage). However, in comparison to the second configuration, the power processing blocks of the field configurable array are configured differently. In particular, the first PV array 310 and the second PV array 312 are both connected to a fifth group 340 of power processing blocks. The fifth group 340 of power processing blocks comprises four DC/DC power processing blocks and two DC/AC power processing blocks. This configuration may be used if the DC/AC power processing blocks can operate with double the maximum power as the DC/DC power processing blocks. Further, the third PV array 320 is connected to a sixth group 342 of power processing blocks. The sixth group comprises the same number of power processing blocks as the third group 334, but the physical power processing blocks being used are different. In addition, the energy storage 314 is connected to a seventh group 344 of power processing blocks. In comparison to the second configuration illustrated in FIG. 3B, the seventh group 344 of power processing blocks is limited to only DC/DC power processing blocks. However, the seventh group 344 of power processing blocks can be used in conjunction with the eighth group 346 of power processing blocks, which comprises only DC/AC power processing blocks. For example, the output of the DC/DC power converters of the seventh group 344 of power processing blocks can be connected to the input of the DC/AC power converters of the eighth group 346 of power processing blocks.

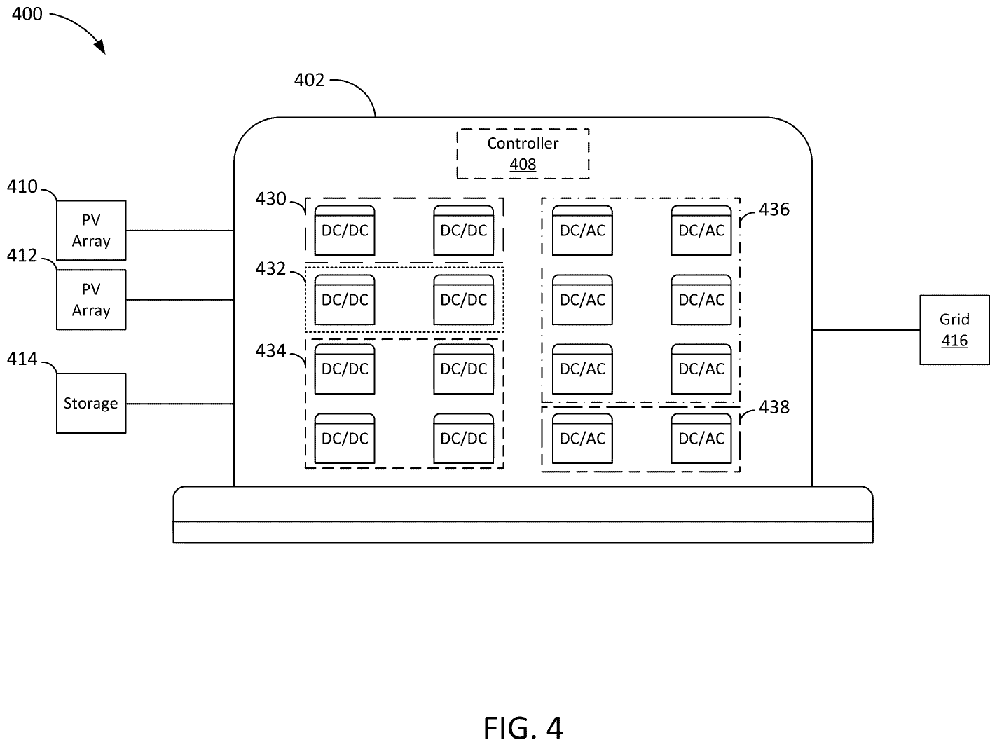

FIG. 4 is a schematic view of an example system including a field configurable array of power processing blocks in a fourth configuration according to an aspect of the present disclosure. In the illustrated example, a first PV array 410 is connected to a first group 430 of power processing blocks, a second PV array 412 is connected to a second group 432 of power processing blocks, and energy storage 414 is connected to a third group 434 of power processing blocks. The first, second and third groups 430, 432, 434 of power processing blocks comprise only DC/DC power processing blocks. Additionally, a fourth group 436 and a fifth group 436 of power processing blocks comprise only DC/AC power processing blocks. The first and second group 430, 432 of power processing blocks are connected to the fourth group 436 of power processing blocks to enable power from the first and second PV arrays 410, 412 to be output to the grid. In some examples, the first and second group 430, 432 of power processing blocks are connected to the third group 434 of power processing blocks to enable power from the first and second PV arrays 410, 412 to be output to the energy storage 414. The third group 434 of power processing blocks can be connected to the fifth group 438 of power processing blocks to enable the energy storage 414 to both output energy to the grid 416 and to receive energy from the grid 416. In the fourth configuration, the energy storage 414 is connected to more DC/DC power processing blocks than each individual PV array as the energy storage 414 can be sized larger (e.g., larger capacity) than the PV arrays. Additionally, by having the DC/AC power processing blocks in separate groups from the DC/DC power processing blocks, the controller 408 can dynamically adjust how much power from each of the DC sources (e.g., first PV array 410, second PV array 412, and energy storage 414) is output through the DC/AC power processing blocks.

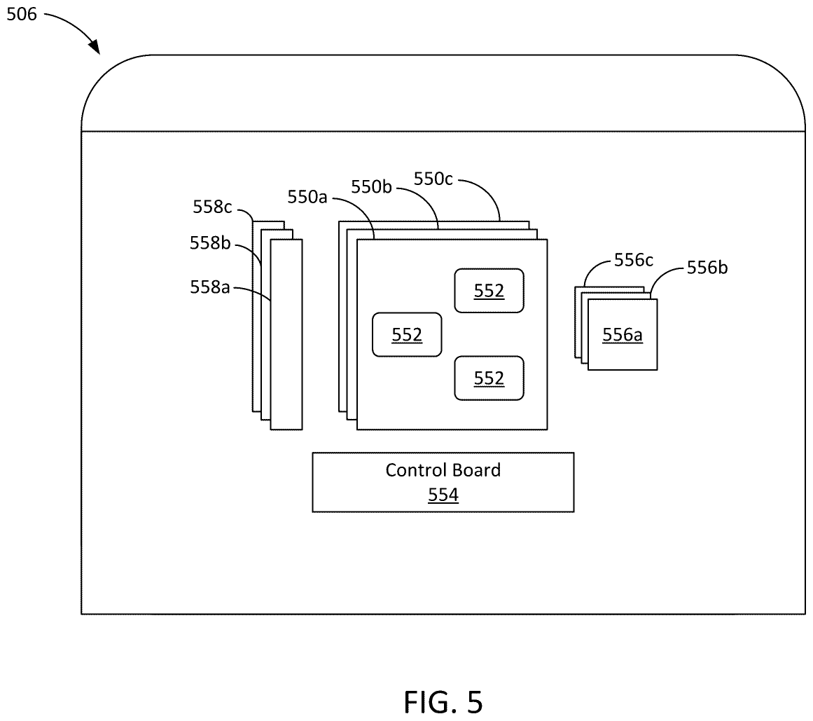

FIG. 5 is a schematic view of an example power processing block 506 in a DC/AC configuration according to an aspect of the present disclosure. The power processing block 506 includes a series of sub-processing blocks 550a, 550b, 550c that are connected in parallel with one another. While three sub-processing blocks 550a, 550b, 550c are illustrated, any number of sub-processing blocks can be used. Each sub-processing block 550a, 550b, 550c can be rated to operate at a maximum power level. Connecting the sub-processing blocks 550a, 550b, 550c in parallel can increase the maximum power level at which the power processing block 506 can operate. In some examples, each of the sub-processing blocks 550a, 550b, 550c can operate as one phase of a multi-phase (e.g., three-phase) system.

Each of the sub-processing blocks 550a, 550b, 550c includes three power converters 552, though any number of power converters can be used. The converters 552 can be connected to one another and in some examples, two or more of the power converters 552 operate together. The power converters 552 can each be used for one phase of a multi-phase (e.g., three-phase) system and/or can be used together for one phase of a multi-phase system. In general, the sub-processing blocks 550a, 550b, 550c can each operate to convert DC voltage to AC voltage. In some embodiments, the power converters 552 comprise half-bridge converter circuits. Other circuit topologies can be used for the sub-processing blocks 550a, 550b, 550c and this disclosure is not limited to using half-bridge converter circuits. For instance, in some embodiments, each of the sub-processing blocks 550a, 550b, 550c comprise a single full-bridge converter circuit and/or an active neutral point clamped bridge.

The power processing block 506 additionally includes a control board 554 which can be configured to control the sub-processing blocks 550a, 550b, 550c and/or the power converters 552 of each sub-processing block 550a, 550b, 550c. For example, the control board 554 can be configured to operate a specific set of the sub-processing blocks 550a, 550b, 550c dependent upon power level requirements and/or upon phase requirements. The power processing block 506 further includes inductors 556a, 556b, 556c. While multiple inductors 556a, 556b, 556c are illustrated in the example of FIG. 5, in some embodiments, any number of inductors (e.g., one larger inductor) can be used. The inductors 556a, 556b, 556c are connected to their respective sub-processing blocks 550a, 550b, 550c and can be used in conjunction with the sub-processing blocks 550a, 550b, 550c to output an AC voltage from a DC input voltage. In some examples, the AC output voltage can be adjustable via the control board 554. For instance, the control board 554 can control switching and/or PWM of the power converters 552 to adjust the AC output voltage. The power processing block 506 also includes input capacitors 558a, 558b, 558c. While multiple input capacitors 558a, 558b, 558c are illustrated in the example of FIG. 5, any number of capacitors can be used. The input capacitors 558a, 558b, 558c are connected to their respective sub-processing blocks 550a, 550b, 550c and can be used in conjunction with the sub-processing blocks 550a, 550b, 550c to output an AC voltage from a DC input voltage.

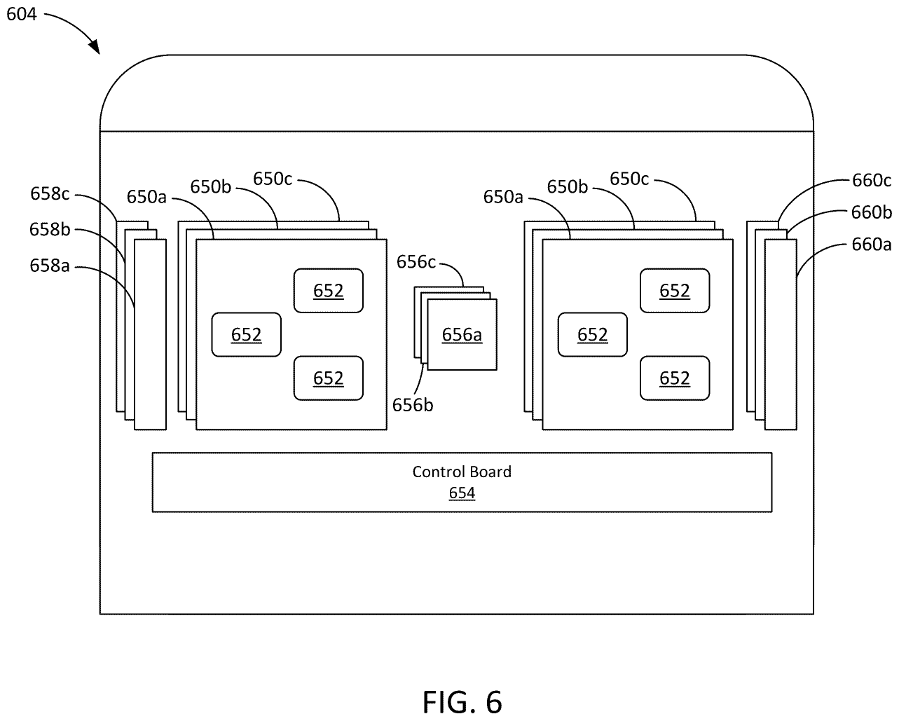

FIG. 6 is a schematic view of an example power processing block 604 in a DC/DC configuration according to an aspect of the present disclosure. The power processing block 604 includes two sets of three sub-processing blocks 650. Within a set, the three sub-processing blocks 650a, 650b, 650c are connected in parallel with one another. However, the two sets are connected in series with each other. While three sub-processing blocks 650a, 650b, 650c are illustrated, any number of sub-processing blocks can be used in each set. Each sub-processing block 650a, 650b, 650c can be rated to operate at a maximum power level. Connecting the sub-processing blocks within each set in parallel can increase the maximum power level at which the power processing block 604 can operate. In some examples, each of the sub-processing blocks 650a, 650b, 650c can operate as one phase of a multi-phase (e.g., three-phase) system.

Each of sub-processing blocks 650a, 650b, 650c includes three power converters 652, though any number of power converters can be used. The converters 652 can be connected to one another and in some examples, two or more of the power converters 652 operate together. The power converters 652 can each be used for one phase of a multi-phase (e.g., three-phase) system and/or can be used together for one phase of a multi-phase system. In general, the sub-processing blocks 650a, 650b, 650c can each operate to convert DC voltage to AC voltage. However, by using two sets of sub-processing blocks 650a, 650b, 650c connected in series, a DC voltage can be converted to an AC voltage in the first set of sub-processing blocks and subsequently converted from the AC voltage to a DC voltage in the second set of sub-processing blocks. In some embodiments, in similarity with the power processing block 506 of FIG. 5, the power converters 652 comprise half-bridge converter circuits. Other circuit topologies can be used for the sub-processing blocks 650a, 650b, 650c and this disclosure is not limited to using half-bridge converter circuits. For instance, in some embodiments, each of the sub-processing blocks 650a, 650b, 650c comprise a single full-bridge converter circuit and/or an active neutral point clamped bridge.

The power processing block 604 additionally includes a control board 654 which can be configured to control the two sets of sub-processing blocks 650a, 650b, 650c and/or the power converters 652 of each sub-processing block. For example, the control board 654 can be configured to operate some of the sub-processing blocks 650a, 650b, 650c dependent upon power level requirements and/or upon phase requirements. The power processing block 604 also includes inductors 656a, 656b, 656c. While multiple inductors 656a, 656b, 656c are illustrated in the example of FIG. 6, in some embodiments, any number of inductors (e.g., one larger inductor) can be used. The inductors 656a, 656b, 656c are connected on each side to their respective sub-processing blocks 650a, 650b, 650c and can be used in conjunction with both sets of the sub-processing blocks to output a DC voltage from a DC input voltage. The DC output voltage can be higher than, lower than, or equal to the DC input voltage and in some examples, is adjustable via the control board 654. For instance, the control board 654 can control switching and/or PWM of the power converters 652 to adjust the output DC voltage. The power processing block 604 also includes input capacitors 658a, 658b, 658c and output capacitors 660a, 660b, 660c. While multiple input/output capacitors are illustrated in the example of FIG. 6, any number of capacitors can be used. The input capacitors 658a, 658b, 658c are connected to the first set of their respective sub-processing blocks and can be used in conjunction with the first set of sub-processing blocks to output an AC voltage from a DC input voltage. Similarly, the output capacitors 660a, 660b, 660c are connected to the second set of their respective sub-processing blocks and can be used in conjunction with the second set of sub-processing blocks to output a DC voltage from an AC input voltage (e.g., from the first set of sub-processing blocks).

Referring generally to FIGS. 1-6, a DC/DC power processing block can be configured to become a DC/AC power processing block and a DC/AC power processing block can be configured to become a DC/DC power processing block. To enable such configurability, each sub-processing block (e.g., 550a, 650a) can be connected/disconnected from one of a first DC bus, a second DC bus, and a third, AC bus (also referred to as “AC bus”). Further, each sub-processing block can be connected/disconnected from additional components such as inductors (e.g., 556a, 656a) and capacitors (e.g., 558a, 658a, 660a) to enable sub-processing blocks to act as DC/AC power processing blocks or as DC/DC power processing blocks (e.g., when connected in series with another sub-processing block).

In some embodiments, the DC/DC power processing block can be configured to become two DC/AC power processing blocks by connecting/disconnecting the inputs and/or outputs of each sub-processing block that make up the DC/DC power processing block to the first DC bus, the second DC bus, and the AC bus. For example, a first sub-processing block (e.g., left side of FIG. 6) can have its output disconnected from the input to a second sub-processing block (e.g., right side of FIG. 6) and reconnected to an AC bus. Further, the second sub-processing block can have its input disconnected from the first sub-processing block and its output disconnected from a first DC bus (e.g., for connections within the field configurable array). The input of the second sub-processing block can then be connected to the AC bus and the output of the second sub-processing block can be connected to the second DC bus (e.g., for connection to a PV array).

To connect/disconnect the inputs and outputs of each sub-processing block, a controller (e.g., 108a, 108b) can control switches within the field configurable array. The switches can comprise mechanical switches (e.g., relays), electronic switches (e.g., transistors), and/or the like. In some embodiments, the controller can adjust a pulse width modulation (PWM) signal and/or switching patterns of each sub-processing block to enable the sub-processing blocks to operate as DC/DC power processing blocks or as DC/AC power processing blocks.

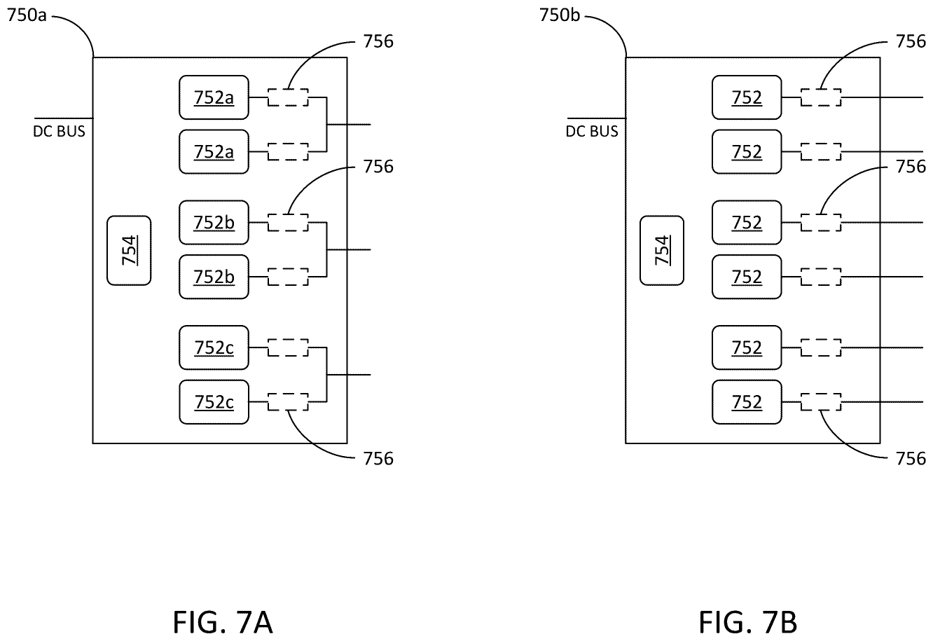

FIG. 7A is a schematic view of an example sub-processing block 750a according to an aspect of the present disclosure. In comparison to the sub-processing blocks of FIG. 5 and FIG. 6, the sub-processing block 750a includes six power converters 752a, 752b, 752c. The power converters 752a, 752b, 752c can be connected to one another and in some examples, two or more of the converters 752a, 752b, 752c operate together. For instance, in the illustrated embodiment, power converters 752a are connected together, power converters 752b are connected together, and power converters 752c are connected together. In general, the sub-processing block 750a is configured to convert a DC voltage to an AC voltage. As illustrated, the sub-processing block 750a can be connected to a DC bus acting as an input, from which it can receive a DC voltage. Then, in converting the DC voltage to an AC voltage, each of the pairs of power converters 752a, 752b, 752c can be used for one phase of a three-phase AC power system. Each of the power converters 752a, 752b, 752c can comprise various circuit topologies including, but not limited to, a half-bridge converter, an active neutral point clamped converter, and a full-bridge converter.

The sub-processing block 750a also includes inductors 756. While multiple inductors 756 are illustrated, in some examples, any number of inductors (e.g., one larger inductor) can be used. The inductors 756 are connected on one side to a respective power converter 752a, 752b, 752c and are connected together in corresponding pairs to an output (e.g., one phase of a three-phase AC system). The inductors 756 can be used in conjunction with the power converters 752a, 752b, 752c to output an AC voltage from a DC input voltage. In some examples, one or more input and/or output capacitors can be included with the sub-processing block 750a. The input and/or output capacitor(s) can be used in conjunction with the power converters 752a, 752b, 752c to output an AC voltage from a DC input voltage.

The sub-processing block 750a can additionally including a control board 754 which can be configured to control the power converters 752a, 752b, 752c of the sub-processing block 750a. In some examples, the control board 754 can adjust an AC output voltage of one or more phases from a given DC input voltage. For instance, the control board 754 can control switching and/or PWM of the power converters 752a, 752b, 752c to adjust the AC output voltage. The sub-processing block 750a can have a power rating of approximately 120 kW of AC output power when operating as a DC/AC converter.

FIG. 7B is a schematic view of an alternate sub-processing block 750b according to an aspect of the present disclosure. The sub-processing block 750b of FIG. 7B is similar to the sub-processing block 750a of FIG. 7A in that it includes six power converters 752, six inductors 756, and a controller 754. While each power converter 752 is illustrated as being connected to a separate inductor 756, any number of inductors (e.g., one larger inductor) can be used. However, the sub-processing block 750b differs from the sub-processing block 750a of FIG. 7A in that it includes power converters 752 that are not connected together. Instead, the connections to the power converters 752 (e.g., on the right side of the sub-processing block 750b) can each act as a bi-directional (e.g., input or output) power port. The bi-directional power ports enable the sub-processing block 750b of FIG. 7B to operate as a DC/DC converter. Accordingly, the sub-processing block 750b is configured to convert a DC input voltage from one or more of the bi-directional power ports to a DC output voltage on one or more of the bi-directional power ports. Any number of the bi-directional power ports can be configured to be input DC ports. Similarly, any number of the bi-directional power ports can be configured to be output DC ports. In one example, the number of bi-directional ports configured to be input DC ports is the same as the number of bi-directional ports configured to be output DC ports. In some examples, while the sub-processing block 750b can be connected to a DC bus on one side (e.g., the left side of the sub-processing block 750b), the sub-processing block 750b may not use the DC bus as an input or output in certain configurations. While the DC bus and the bi-directional power ports/connections to the power converters 752, 752a, 752b, 752c are illustrated as individual connection lines, a person having ordinary skill in the art will understand each connection can include multiple wires/connections. For example, a connection that is a DC connection can include a positive DC connection and a negative connection.

As illustrated, the sub-processing block 750b can act as a buck-boost converter, whereby a DC output voltage on one or more of the bi-directional power ports can be higher than, lower than, or equal to the DC input voltage on one or more of the bi-directional power ports. In some examples, the DC output voltage is adjustable via the controller 754. For instance, the controller 754 can control switching and/or PWM of the power converters 752 to adjust the output DC voltage.

Referring to both FIGS. 7A and 7B, the sub-processing blocks 750a and 750b can have the same physical components and can, in some embodiments, be reconfigured to operate differently. For instance, the sub-processing block 750b, which is configured to operate as a DC/DC converter (e.g., a buck-boost converter), can be reconfigured to operate as a DC/AC converter. Similarly, the sub-processing block 750a, which is configured to operate as a DC/AC converter, can be reconfigured to operate as a DC/DC converter. To enable such configurability, internal/external connections (e.g., jumpers) between the power converters can be connected or disconnected. The internal/external connections/disconnections can be made manually (e.g., jumpers) and/or automatically (e.g., relays, switches, transistors). For example, the sub-processing blocks 750a and 750b can include a DC bus connection and six bi-directional port connections. As illustrated with the sub-processing block 750a, the six bi-directional ports can be connected in pairs while in the sub-processing block 750b, the six bi-directional ports can be separated. Accordingly, to change operation, one or more of the six bi-directional ports can be connected together and/or disconnected from one another. In addition to or in lieu of connecting/disconnecting internal/external connections, the controller 754 can change its switching and/or PWM of the power converters to reconfigure the sub-processing block 750a or the sub-processing block 750b to operate as the other sub-processing block does.

For example, while the sub-processing block 750a of FIG. 7A has been described as operating to convert a DC input voltage to an AC output voltage, in some embodiments, the sub-processing block 750a can be configured to operate to convert a DC input voltage to a DC output voltage. In some such embodiments, the DC output voltage can be higher than the DC input voltage (e.g., a boost converter). While no physical connections may change, the previous DC input (left side of the sub-processing block 750a) can become the DC output while the previous AC outputs (right side of the sub-processing block 750a) can become DC inputs. In some examples, the inputs are connected together to a common DC bus having a DC output voltage. Alternatively, one or more of the inputs can be separate (e.g., connected to different DC buses).

To enable the sub-processing block 750a to operate as a DC/DC converter rather than a DC/AC converter, the controller 754 can control switching and/or PWM of the power converters 752a, 752b, 752c. The controller 754 can also control the switching and/or PWM of the power converters 752a, 752b, 752c to adjust a DC output voltage. In the illustrated embodiment, the sub-processing block 750a can operate as a boost converter that takes an input DC voltage and outputs a DC voltage that is greater than the input DC voltage. When operating as a DC/DC converter, and more specifically as a boost converter, the sub-processing block 750a can have a power rating that is greater (e.g., at least double) than when the sub-processing block operates as a DC/AC converter. For instance, the sub-processing block 750a can have a power rating of approximately 300 kW when operating as a DC/DC boost converter, which is greater than double of when the sub-processing block 750a operates as a DC/AC converter.

Again referring to both FIG. 7A and FIG. 7B, in some examples, one or more of the bi-directional ports and/or the DC connection can include electrical protection (e.g., fuses, contactors, relays, circuit breakers, disconnects). In some such examples, electrical protection is included in only a pre-determined subset of the bi-directional ports and/or the DC connection. The pre-determined subset of bi-directional ports and/or the DC connection can be specifically chosen so that if the sub-processing block 750a, 750b is reconfigured to operate as a DC/DC converter or a DC/AC converter, the electrical protection can continue to protect the bi-directional ports and/or the DC connection. Limiting electrical protection to a subset of the bi-directional ports can help reduce cost and complexity.

In some embodiments, the reconfigurability of the sub-processing block 750a, 750b can be made to be limited. For example, the sub-processing block 750a can be limited to operate as either a DC/AC converter or a DC/DC boost converter (e.g., not a DC/DC buck-boost converter). In some examples, to limit the reconfigurability of the sub-processing block 750a, 750b, the connections between the bi-directional ports is limited to specific configurations (e.g., limited to being connected in pairs of two). Limiting the reconfigurability of the sub-processing block 750a, 750b can reduce the cost and complexity of the sub-processing block 750a, 750b.

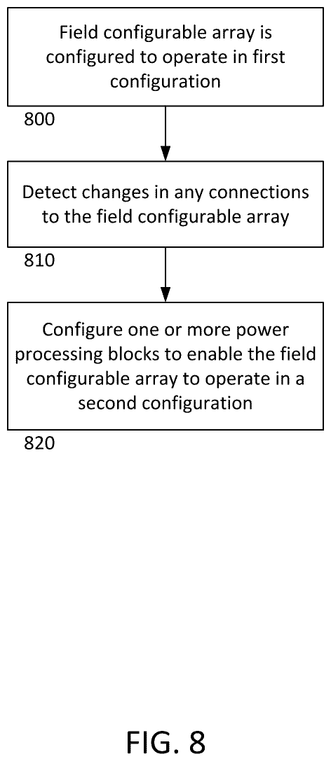

FIG. 8 is a flow diagram of an example method of configuring a field configurable array of power processing blocks according to an aspect of the disclosure. The flow starts at 800, where the field configurable array is configured to operate in a first configuration. For example, in the first configuration, the field configurable array is connected to two inputs, a first PV array and a second PV array, and one output, the grid. Next, at 810, flow continues with detecting a change in connections made to the field configurable array. Continuing with the example, the change in connections made to the field configurable array comprise a second configuration. The second configuration differs from the first configuration in that a third PV array is connected as an input to the field configurable array and energy storage is connected as both an input and an output to the field configurable array. In some examples, a controller of the field configurable array is configured to detect changes in connections. Next, at 820, flow continues with configuring one or more power processing blocks to enable the field configurable array to operate in a second configuration, the second configuration comprising the changes made to the first configuration. Further continuing with the example, additional DC/DC power processing blocks and DC/AC power processing blocks are allocated to the third PV array and to the energy storage. Additionally, the controller is configured to enable power to flow from the first, second, and third PV arrays to one or both of the grid and the energy storage via the power processing blocks. The controller is also configured to enable power to flow from the energy storage to the grid through the power processing blocks.

Various examples have been described. These and other examples are within the scope of the following claims.

What is claimed is:

1. A configurable power block system, comprising:
a plurality of power processing blocks configured to convert power between a first voltage and second voltage different from the first voltage; and
a plurality of switches configurable to:
electrically connect one or more of the plurality of power processing blocks to another one or more of the plurality of power processing blocks to form a group of power processing blocks; and
electrically connect the group of power processing blocks to a first electrical connection and a second electrical connection.

2. The system of claim 1, wherein each of the plurality of power processing blocks include one or more sub-processing blocks configured to convert power between a first voltage and a second voltage, and wherein each of the plurality of sub-processing block includes a plurality of power converters.

3. The system of claim 2, wherein the one or more sub-processing blocks are configured to convert power between a first DC voltage and an AC voltage.

4. The system of claim 3, wherein the one or more sub-processing blocks are re-configured to convert power between a first DC voltage and a second DC voltage.

5. The system of claim 4, further comprising a control board in communication with each of the sub-processing blocks, the control board configured to re-configure the sub-processing blocks between converting power between the first DC voltage and the AC voltage, and converting power between the first DC voltage and the second DC voltage.

6. The system of claim 5, wherein the control board is configured to re-configure the sub-processing blocks using one or both of control switching or pulse width modulation (PWM).

7. The system of claim 2, further comprising a control board configured to control the plurality of power converters to adjust an output voltage from a given input voltage using control switching and/or pulse width modulation (PWM) of the power converters.

8. The system of claim 2, wherein each of the power converters comprises one of a half-bridge converter, an active neutral point clamped converter, or a full-bridge converter.

9. The system of claim 2, wherein the first voltage is a first DC voltage and the second voltage is a second DC voltage, and wherein each of the sub-processing blocks is configured to act as a bi-directional power port.

10. The system of claim 2, wherein each of the plurality of sub-processing blocks are electrically connectable to one or more other sub-processing blocks of the plurality of sub-processing blocks.

11. The system of claim 10, wherein the plurality of sub-processing blocks are coupled into three pairs of sub-processing blocks, each pair of sub-processing blocks configured to convert input DC power into one phase of AC output power.

12. The system of claim 1, wherein the first voltage comprise a first DC voltage, and the second voltage comprises one of a second DC voltage or an AC voltage.

13. The system of claim 1, further comprising a second plurality of power processing blocks configured to convert power between a third voltage and a fourth voltage different from the third voltage;
wherein the plurality of switches are further configurable to:
electrically connect one or more of the second plurality of power processing blocks to another one or more of the second plurality of power processing blocks to form a second group of power processing blocks; and
electrically connect the second group of power processing blocks to a third electrical connection and a fourth electrical connection.

14. The system of claim 13, wherein the fourth voltage is equivalent to the second voltage and comprises an AC voltage and the fourth electrical connection is equivalent to the second electrical connection and is connected to an electric grid.

15. The system of claim 1, further comprising a controller in communication with the plurality of power processing blocks and the plurality of switches, the controller configured to:
determine a number of power processing blocks required for the first electrical connection; and
connect, via activation of the plurality of switches, the determined number of power processing blocks required for the first electrical connection with one another, the first electrical connection, and/or the second electrical connection.

16. The system of claim 15, wherein the controller is configured to determine the number of power processing blocks required for the first electrical connection based on an electrical load or electrical supply of the first electrical connection and on one or more maximum power ratings of the plurality of power processing blocks.

17. The system of claim 16, wherein the controller receives the electrical load of the first electrical connection and/or the one or more maximum power ratings of the plurality of power processing blocks from an external device.

18. The system of claim 15, wherein the plurality of power processing blocks comprises a first series of power processing blocks, the first voltage for the first series of power processing blocks being a first DC voltage and the second voltage for the first series of power processing blocks being a second DC voltage, the first series of power processing blocks configured to convert power between the first DC voltage and the second DC voltage.

19. The system of claim 18, wherein each of the first series of power processing blocks comprises a first series of sub-processing blocks connected in series with a second series of sub-processing blocks, each of the first series and the second series of sub-processing blocks comprising a plurality of DC/AC converters, the first series of sub-processing blocks configured to operate with the second series of sub-processing blocks to convert power between the first DC voltage and the second DC voltage via an intermediate AC voltage.

20. The system of claim 18, wherein the plurality of power processing blocks comprises a second series of power processing blocks, the first voltage for the second series of power processing blocks being the second DC voltage and the second voltage for the second series of power processing blocks being an AC voltage.

21. The system of claim 20, wherein each of the second series of power processing blocks comprises a first series of sub-processing blocks connected in parallel with a second series of sub-processing blocks, each of the first series and the second series of sub-processing blocks comprising a plurality of DC/AC converters, the first series of sub-processing blocks configured to operate with the second series of sub-processing blocks to convert power between the second DC voltage and the AC voltage.

22. The system of claim 20, wherein in determining the number of power processing blocks required for the first electrical connection, the controller is configured to determine a number of power processing blocks in the first series of power processing blocks and determine a number of power processing blocks in the second series of power processing blocks.
